(19) United States
(12) Patent Application Publication
(10) Pub. No.: US 2007/0005829 A1
(43) Pub. Date: Jan. 4, 2007

(54) Memory card having memory element and card controller thereof

(76) Inventor: Akihisa Fujimoto, Fussa-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/502,409

(22) Filed: Aug. 11, 2006

Related U.S. Application Data
(63) Continuation of application No. PCT/JP05/09596, filed on May 19, 2005.

(30) Foreign Application Priority Data
Nov. 12, 2004 (JP) 2004-328846

(51) Int. Cl. G06F 3/00

(52) U.S. Cl. 710/48

(57) ABSTRACT

A card controller is built in a memory card capable of being loaded in a host device which can detect interrupt. The interface unit receives and decodes a command from the host device, sends a response or data to the host device, and receives data therefrom. The read/write control unit executes writing and reading of the data in accordance with a result of decoding the command. The error detecting unit detects whether an error occurred in the sending and receiving of the data executed by the interface unit, and in at least one of the writing and reading of the data executed by the read/write control unit. The signal processing unit outputs an interrupt signal to the host device via the interface unit during a period in which the interface unit does not execute sending or receiving the data, when the error detecting unit detects the occurrence of the error.

### CROSS-REFERENCE TO RELATED APPLICATIONS

This is a Continuation Application of PCT Application No. PCT/JP2005/009596, filed May 19, 2005, which was published under PCT Article 21(2) in English.

This application is based upon and claims the benefit of priority from prior Japanese Patent Application No. 2004-328846, filed Nov. 12, 2004, the entire contents of which are incorporated herein by reference.

### BACKGROUND OF THE INVENTION

1. Field of the Invention

This invention relates to a memory card having a memory element and a card controller thereof and, more particularly, to a memory card which allows writing data therein and reading data therefrom by an access from a host device and a card controller thereof.

2. Description of the Related Art

Recently, memory cards have been frequently used as one of removable memory devices, in various portable electronic devices such as personal computers, PDA, cameras, mobile telephones and the like. As the memory cards, attention is focused on a PC card and a small-size SD™ card (see Jpn. PAT. Appln. KOKAI Publication No. 2003-91703). The SD™ card is a memory card in which a flash memory is built. This card is particularly designed to meet requirements of downsizing, large capacity, and high-speed processing.

In a case where an error occurs in an access of the host device to the SD™ card, the host device needs to issue an access command such as writing, reading or the like, further issue a command for the SD™ card to confirm whether an error occurred, and finally confirm whether an error occurred in accordance with the response signal to the command.

To confirm an error which rarely occurs, however, the host device needs to issue a command to confirm an error after issuing an access command, which prevents simplification of a memory card controlling method for the host device. If the memory card has further wireless communication means or wire communication means, the memory card needs to have means for notifying the host device of information about the occurrence of the error. For the host device, however, there is no means for acquiring information generated in the wireless or wire communications other than constantly executing polling.

### BRIEF SUMMARY OF THE INVENTION

According to an aspect of the present invention, there is provided a card controller built in a memory card capable of being loaded in a host device which can detect interrupt. The card controller comprises an interface unit which receives and decodes a command from the host device, sends a response to the host device, and sends data to the host device and receives data therefrom, a read/write control unit which executes at least one of writing and reading of the data in accordance with a result of decoding the command, an error detecting unit which detects whether an error occurred in the sending and receiving of the data executed by the interface unit, and in at least one of the writing and reading of the data executed by the read/write control unit, and a signal processing unit which outputs an interrupt signal to the host device via the interface unit during a period in which the interface unit does not execute sending or receiving the data, when the error detecting unit detects the occurrence of the error.

According to another aspect of the present invention, there is provided a card controller built in a memory card capable of being loaded in a host device which can detect interrupt. The card controller comprises a communications unit which sends information to an external device and receives information therefrom, an interface unit which receives and decodes a command from the host device, sends a response to the host device, and sends data to the host device and receives data therefrom, a read/write control unit which executes at least one of writing and reading of the data in accordance with a result of decoding the command, and a signal processing unit which outputs predetermined information sent from the communications unit to the host device via the interface unit, as an interrupt signal, during a period in which the interface unit does not execute sending and receiving of the data.

According to still another aspect of the present invention, there is provided a memory card capable of being loaded in a host device which can detect interrupt and being accessed by the host device. The memory card comprises an interface unit which receives and decodes a command from the host device, sends a response to the host device, and sends data to the host device and receives data therefrom, a memory which stores the data, a read/write control unit which executes at least one of writing of the data to the memory and reading of the data therefrom in accordance with a result of decoding the command, an error detecting unit which detects whether an error occurred in the sending and receiving of the data executed by the interface unit, and in at least one of the writing and reading of the data executed by the read/write control unit, and a signal processing unit which outputs an interrupt signal to the host device via the interface unit during a period in which the interface unit does not execute sending or receiving the data, when the error detecting unit detects the occurrence of the error.

According to further another aspect of the present invention, there is provided a memory card capable of being loaded in a host device which can detect interrupt and being accessed by the host device. The memory card comprises a communications unit which sends information to an external device and receives information therefrom, an interface unit which receives and decodes a command from the host device, sends a response to the host device, and sends data to the host device and receives data therefrom, a memory which stores the data, a read/write control unit which executes at least one of writing of the data to the memory and reading of the data therefrom in accordance with a result of decoding the command, and a signal processing unit which outputs predetermined information sent from the communications unit to the host device via the interface unit, as an interrupt signal, during a period in which the interface unit does not execute sending and receiving of the data.

### BRIEF DESCRIPTION OF THE SEVERAL VIEWS OF THE DRAWING

FIG. 1 is an illustration schematically showing a structure of an SD™ memory card according to a first embodiment of the present invention;

FIG. 2 is a table showing assignment of signals to signal pins in the SD™ memory card according to the first embodiment;

FIG. 3 is a block diagram showing a hardware configuration of the SD™ memory card according to the first embodiment;

FIG. 4 is a block diagram showing a detailed structure of a register unit in the SD™ memory card according to the first embodiment;

FIG. 5 is an illustration showing arrangement of data in a NAND-type flash memory in the SD™ memory card according to the first embodiment;

FIG. 6 is a table showing assignment of signals to the signal pins in the operation modes;

FIG. 7 is a functional block diagram showing a structure of an SD™ memory card according to the first embodiment;

FIG. 8 is a timing chart showing a data cycle and an interrupt cycle, at the time of writing in the SD™ memory card;

FIG. 9 is a timing chart showing sending and receiving of a signal between the host device and the SD™ memory card, at the time of single write in the SD™ memory card according to the first embodiment;

FIG. 10 is a timing chart showing sending and receiving of a signal between the host device and the SD™ memory card, at the time of multi-block write in the SD™ memory card according to the first embodiment;

FIG. 11 is a timing chart showing another example of sending and receiving of a signal between the host device and the SD™ memory card, at the time of multi-block write in the SD™ memory card according to the first embodiment;

FIG. 12 is an illustration schematically showing a structure of an SD™ memory card according to a second embodiment of the present invention;

FIG. 13 is a table showing assignment of signals to signal pins in the SD™ memory card according to the second embodiment;

FIG. 14 is a functional block diagram showing a structure of an SD™ memory card according to the second embodiment;

FIG. 15 is a functional block diagram showing a structure of an SD™ memory card according to a first modified example of the second embodiment; and

FIG. 16 is a functional block diagram showing a structure of an SD™ memory card according to a second modified example of the second embodiment.

### DETAILED DESCRIPTION OF THE INVENTION

A memory card according to embodiments of the present invention will be described below with reference to the accompanying drawings. An SD™ memory card is explained as an example of the memory card. Like elements are denoted by like or similar reference numbers throughout the drawings.

### First Embodiment

First, an SD™ memory card according to a first embodiment of the present invention will be described.

FIG. 1 is an illustration schematically showing a structure of the SD™ memory card according to the first embodiment. An SD™ memory card 1 sends information to a host device 2 or receives information therefrom via a bus interface 3. The SD™ memory card 1 comprises a NAND-type flash memory chip 11, a card controller 12 which controls the NAND-type flash memory chip 11, and a plurality of signal pins (pin 1 to pin 9) 30.

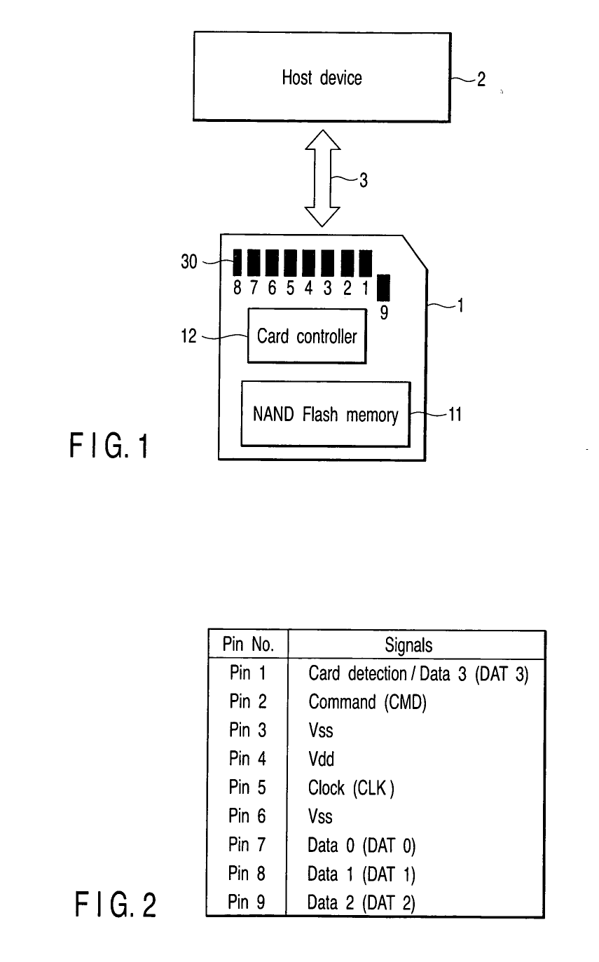

The signal pins 30 are electrically connected to the card controller 12. Signals are assigned to the pin 1 to pin 9 of the signal pins 30, for example, as shown in FIG. 2. Data 0 to data 3 are assigned to the pin 7, pin 8, pin 9 and pin 1, respectively. A card detection signal is also assigned to the pin 1. A command is assigned to the pin 2. A ground potential Vss is assigned to the pin 3 and pin 6. A power supply voltage Vdd is assigned to the pin 4. A clock signal is assigned to the pin 5.

The SD™ memory card 1 is formed to be inserted into a slot provided at the host device 2 or detached therefrom. A host computer (not shown) provided in the host device 2 carries out communications of various signals and data with the card controller 12 inside the SD™ memory card 1 via the pin 1 to pin 9. For example, when data is written in the SD™ memory card 1, the host computer sends a write command to the card controller 12 via the pin 2 as a serial signal. At this time, the card controller 12 receives a write command supplied to the pin 2, in response to the clock signal supplied to the pin 5. As explained above, the write command is input serially to the card controller 12 via the pin 2 alone. The pin 2 assigned to input of the command is arranged between the pin 1 for the data 3 and the pin 3 for the ground potential Vss, as shown in FIG. 2. The signal pins 30 and the interface 3 are used for communications between the host controller provided in the host device 2 and the SD™ memory card 1.

On the other hand, communications between the NAND-type flash memory chip 11 and the card controller 12 employs an interface for a NAND-type flash memory. For this reason, the NAND-type flash memory chip 11 and the card controller 12 are connected to each other by 8-bit I/O lines, though not shown. For example, when the card controller 12 writes data in the NAND-type flash memory chip 11, the card controller 12 sequentially inputs data input command 80H, column address, page address, data and program command 10H to the NAND-type flash memory chip 11, via the 8-bit I/O lines. “H” of command 80H represents a hexadecimal number. Actually, a 8-bit signal “10000000” is supplied in parallel to the 8-bit I/O lines. In other words, the command of plural bits is supplied parallel to the interface for the NAND-type flash memory. In addition, in the interface for the NAND-type flash memory, command and data communications with the NAND-type flash memory chip 11 are made by sharing common I/O lines. Thus, the interface employed for the communications between the host controller in the host device 2 and the SD™ memory card 1 is different from the interface for the communications between the NAND-type flash memory chip 11 and the card controller 12.

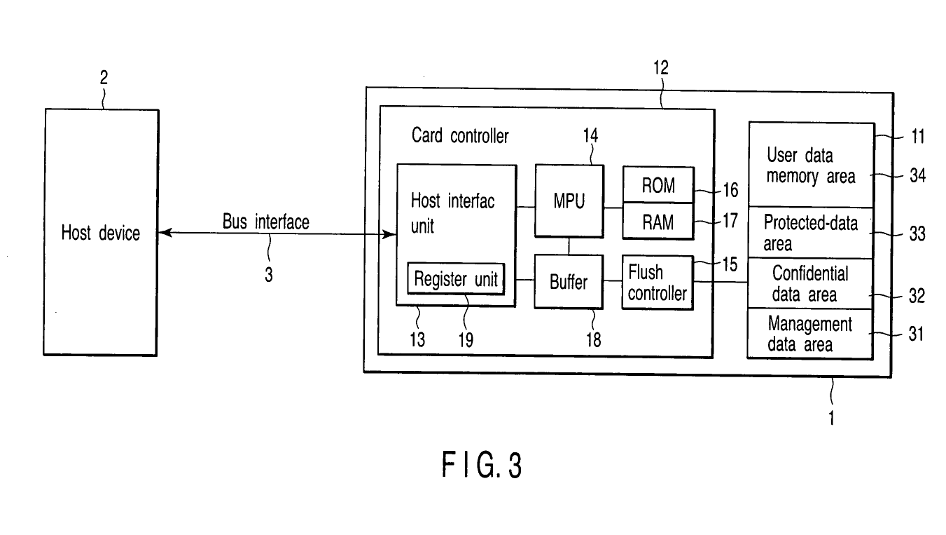

FIG. 3 is a block diagram showing a hardware configuration of the SD™ memory card according to the first embodiment.

The host device 2 comprises hardware and software to make an access to the SD™ memory card 1 connected to the host device 2 via the bus interface 3. When the SD™ memory card 1 is connected to the host device 2, the SD™ memory card 1 receives power and operates, and executes processing responding to the access from the host device 2.

The SD™ memory card 1 comprises the NAND-type flash memory chip 11 and the card controller 12 as explained above. In the NAND-type flash memory chip 11, an erasure block size at the erasing operation (i.e. a block size of an erasure unit) is designed in a predetermined size (for example, 256 kByte). In addition, in the NAND-type flash memory chip 11, data is written and read in a unit called page (for example, 2 kByte). The card controller 12 manages the physical conditions (for example, which physical block address includes what order of logic sector address data or which block is in an erased state) inside the NAND-type flash memory chip 11. The card controller 12 has a host interface unit 13, an MPU (Micro processing unit) 14, a flash controller 15, a ROM (Read-only memory) 16, a RAM (Random access memory) 17 and a buffer 18.

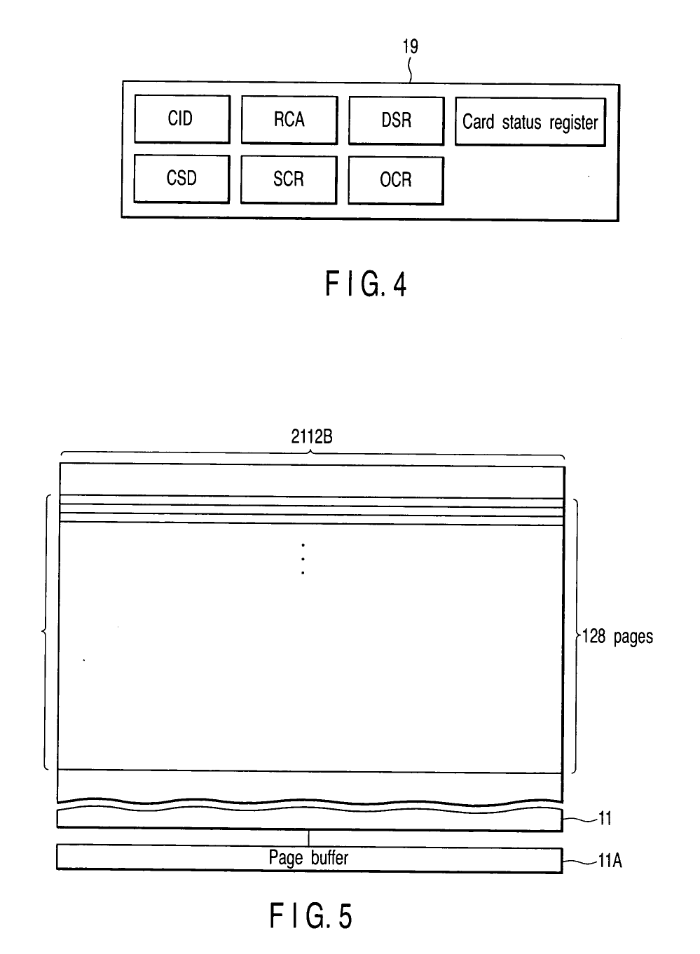

The host interface unit 13 executes interface processing between the card controller 12 and the host device 2, and includes a register unit 19. FIG. 4 shows a detailed structure of the register unit 19. The register unit 19 has a card status register, and various kinds of registers such as CID, RCA, DSR, CSD, SCR and OCR.

These registers are defined in the following manner. The card status register is used in the general operation. For example, error information to be explained later is stored in the card status register. The CID, RCA, DSR, CSD, SCR and OCR are used mainly when the SD™ memory card is initialized. An identification number of the SD™ memory card is stored in the CID. A relative card address (dynamically determined by the host device at the initialization) is stored in the RCA (Relative card address). A bus driving force or the like of the SD™ memory card is stored in the DSR (Driver stage register). A characteristic parameter value of the SD™ memory card is stored in the CSD (Card specific data). Data arrangement of the SD™ memory card is stored in the SCR (SD configuration data register). An operating voltage of the SD™ memory card which is limited in terms of an operating range voltage is stored in the OCR (Operation condition register).

The MPU 14 controls an entire operation of the SD™ memory card 1. For example, when the power is supplied to the SD™ memory card 1, the MPU 14 forms various kinds of tables on the RAM 17 by reading out firmware (control program) stored in the ROM 16 onto the RAM 17 and executing a predetermined processing. The MPU 14 also reads the write command, the read command and the erase command from the host device 2, and executes a predetermined processing for the NAND-type flash memory chip 11 or controls the data transfer by the buffer 18.

The ROM 16 is a memory which stores the control program controlled by the MPU 14, and the like. The RAM 17 is a memory which is used as a working area of the MPU 14 to store the control program and various kinds of tables. The flash controller 15 executes interface processing between the card controller 12 and the NAND-type flash memory chip 11.

The buffer 18 temporarily stores a constant amount of data (for example, data of one page) when the data sent from the host device 2 is written in the NAND-type flash memory chip 11, and temporarily stores a constant amount of data when the data read from the NAND-type flash memory chip 11 is sent to the host device 2.

FIG. 5 shows arrangement of data in the NAND-type flash memory 11 in the SD™ memory card. Each of pages of the NAND-type flash memory chip 11 has 2112 Byte ((512 Byte of the data memory portion+10 Byte of the redundant portion)×4+24 Byte of the management data memory portion). Data of 128 pages is the erasure unit (256 kByte+8 kByte where k represents 1024). In the following explanations, the erasure unit of the NAND-type flash memory chip 11 is called 256 kByte for the sake of convenience.

The NAND-type flash memory chip 11 comprises a page buffer 11A to input the data to the flash memory or output the data therefrom. The storage capacity of the page buffer 11A is 2112 Byte (2048 Byte+64 Byte). When the data is written, the page buffer 11A executes the processing to input the data to the flash memory or output the data therefrom in the unit of 1 page, which corresponds to the own storage capacity.

If the storage capacity of the NAND-type flash memory chip 11 is, for example, 1 G bits, the number of 256-kByte blocks (erasure unit) is 512.

FIG. 5 shows a case where the erasure unit is 256-kByte blocks. For example, the data arrangement having the erasure unit of 16-kByte blocks is practically valid. In this case, each page has 528 Byte (512 Byte of the data memory portion+16 Byte of the redundant portion). Data of 32 pages is the erasure unit (16 kByte+0.5 kByte where k represents 1024).

The area (data memory area) where the data of the NAND-type flash memory chip 11 is written is split into a plurality of areas in accordance with the stored data as shown in FIG. 3. The NAND-type flash memory chip 11 has, as its data memory areas, a user data area 34 where the user data is stored, a management data area 31 where the management information about the SD™ memory card is mainly stored, a confidential data area 32 where confidential data is stored, and a protected-data area 33 where important data is stored.

The user data area 34 is an area which the user using the SD™ memory card 1 can freely access and use. The protected-data area 33 is an area which the user can access only when correctness of the host device 2 is proved by mutual authentication with the host device 2 connected to the SD™ memory card 1.

The management data area 31 is an area where the security information of the SD™ memory card 1 and the card information such as media ID and the like are stored. The confidential data area 32 is an area where key information used for the encryption and the confidential data used at the authentication are stored and which the host device 2 cannot access.

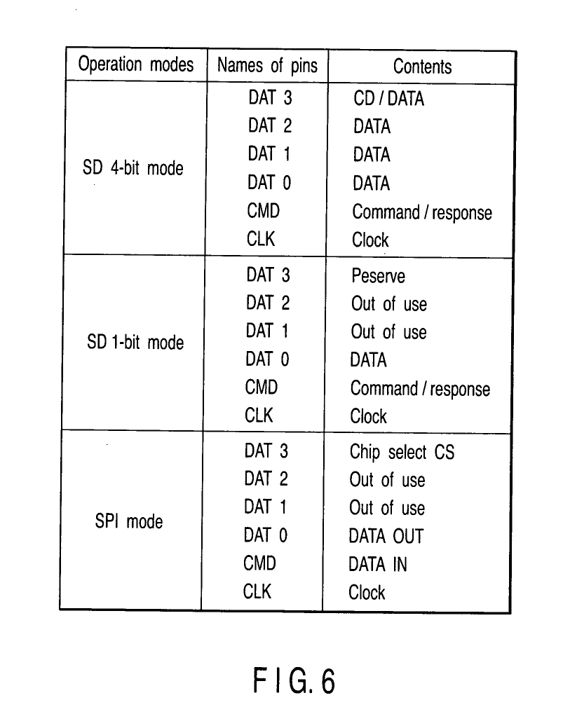

In the first and second embodiments, the operation mode of the SD™ memory card 1 is the SD 4-bit mode. The present invention can also be applied to the SD™ memory card of SD 1-bit mode or SPI mode. FIG. 6 is a table showing assignment of signals to the signal pins in the SD 4-bit mode, the SD 1-bit mode and the SPI mode.

The operation mode of the SD™ memory card is roughly classified into the SD mode and the SPI mode. In the SD mode, the SD™ memory card is set in the SD 4-bit mode or the SD 1-bit mode by a bus width change command sent from the host device.

Four pins, i.e. data 0 pin (DAT0) to data 3 pin (DAT3) are noted here. In the SD 4-bit mode to execute the data transfer in unit of 4-bit width, all of the four pins, i.e. the data 0 pin to the data 3 pin are used for the data transfer. In SD 1-bit mode to execute the data transfer in unit of 1-bit width, the data 0 pin (DAT0) alone is used while the data 1 pin (DAT1) or data 2 pin (DAT2) is not used at all. The data 3 pin (DAT3) is used for, for example, asynchronous interrupt from the SD™ memory card to the host device, and the like. In the SPI mode, the data 0 pin (DAT0) is used for a data signal line (DATA OUT) from the SD™ memory card to the host device. A command pin (CMD) is used for a data signal line (DATA IN) from the host device to the SD™ memory card. The data 1 pin (DAT1) or data 2 pin (DAT2) is not used at all. In the SPI mode, the data 3 pin (DAT3) is used for transmission of a chip select signal CS from the host device to the SD™ memory card.

Next, the operation of the SD™ memory card according to the first embodiment will be explained.

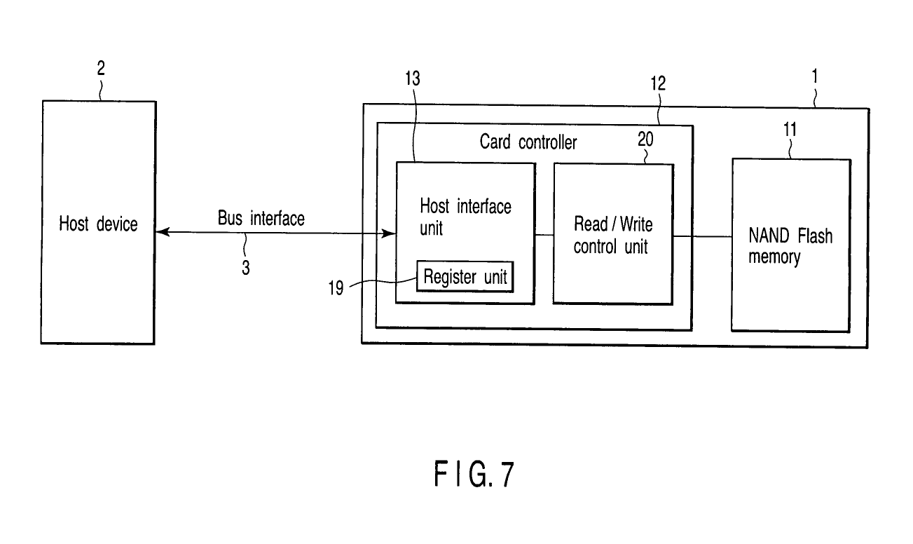

FIG. 7 is a functional block diagram showing a structure of the SD™ memory card according to the first embodiment.

The SD™ memory card 1 is accessed by the host device 2 via the bus interface 3 to execute write and read operations and the like. The SD™ memory card 1 includes the NAND-type flash memory 11 and the card controller 12. The card controller 12 comprises the host interface unit 13 and the read/write control unit 20.

If the host device 2 makes an access to the NAND-type flash memory 11, the host device 2 sends an access command to the host interface unit 13 via the bus interface 3. The host interface unit 13 decodes the access command and sends to the MPU 14 arranged inside the read/write control unit 20 an instruction to make an access to the NAND-type flash memory 11. The MPU 14 makes an access to the NAND-type flash memory 11 via the flash controller 15 arranged inside the read/write control unit 20. The MPU 14 also comprises an error detecting unit. The error detecting unit detects whether an error occurs during the data transfer or the access to the NAND-type flash memory 11. If the occurrence of the error is detected by the error detecting unit, the MPU 14 retains the error information indicating the occurrence of the error in the card status register of the register unit 19 arranged inside the host interface unit 13. When the error information is retained in the register unit 19, the host interface unit 13 outputs an error signal (interrupt signal) to the host device 2 via the bus interface 3 and notifies the host device 2 that the error occurred. By adopting the interrupt as defined under the SDIO standards as the notification method, the error signal output from the host interface unit 13 can easily be detected by the host device 2 corresponding to the SDIO standards while maintaining the compatibility with the conventional standards. If the host device 2 detects the error signal based on the interrupt, the occurrence of the error can be recognized by a command to read the error information as retained by the card status register of the register unit 19 arranged in the host interface unit 13. Moreover, if the card status register preliminarily retains error status information representing where an error occurred, the host device 2, which detects the error signal based on the interrupt, can acquire more detailed information about the error by reading the error status information retained by the card status register. When the host device 2 is in the normal operation in which it does not detect the error signal, it does not need to read the error status information.

In addition, the host interface unit 13 has mode changing means. The mode changing means changes the mode of outputting the error signal and the mode of not outputting the error signal. For example, when the SD™ memory card 1 is initialized, the mode changing means changes the mode to the mode of outputting the error signal if the mode setting command is input, and to the mode of not outputting the error signal if the mode setting command is not input.

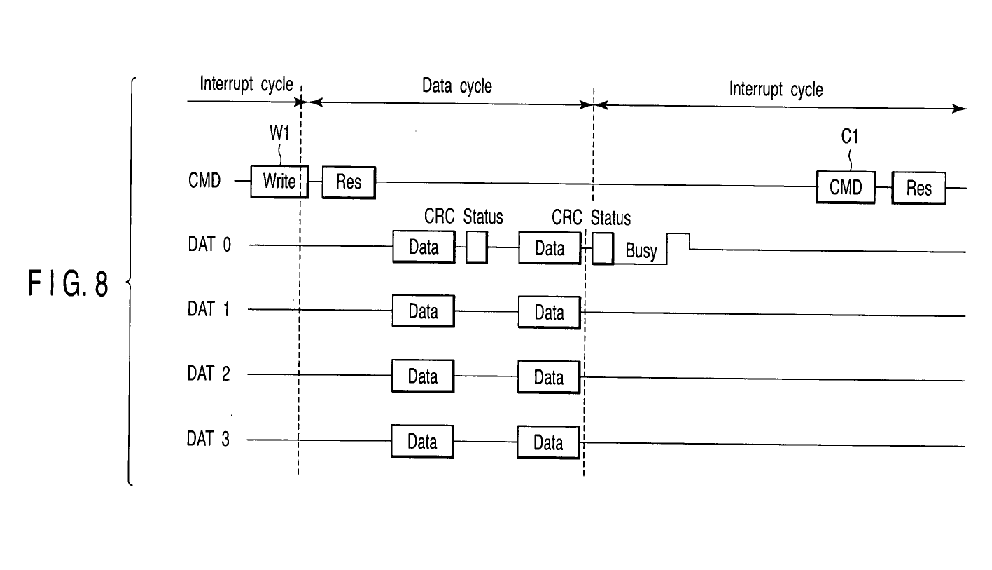

FIG. 8 is a timing chart showing sending/receiving of the signal between the host device 2 and the SD™ memory card 1, at the writing time, i.e. a timing of the signal which passes through the bus interface 3. The data cycle and the interrupt cycle under the SDIO standards to input the data to or output data from the SD™ memory card will be explained with reference to FIG. 8.

Lines of data 0 (DAT0) to data 3 (DAT3) are used for the data cycle and the interrupt cycle in time division, at the writing. The data cycle is set when a command for using the lines of data 0 to data 3 to send and receive the data is input to the SD™ memory card 1. As shown in FIG. 8, a cycle immediately after ending the input of write command W1 and immediately before outputting a CRC status signal for the last data block from the SD™ memory card 1 is the data cycle. Cycles in the other periods are the interrupt cycles. Second command C1 does not use the lines of data 0 to data 3. In this figure, there is no data cycle based on the input of the command C1. The SD™ memory card 1 can output the interrupt to the host device 2 at any time during the interrupt cycle.

Next, a case where an error occurs during the writing in the SD™ memory card according to the first embodiment will be explained.

First, “single write” to write a data block to the NAND-type flash memory 11 by the read/write control unit 20 in accordance with the input of a write command, will be explained.

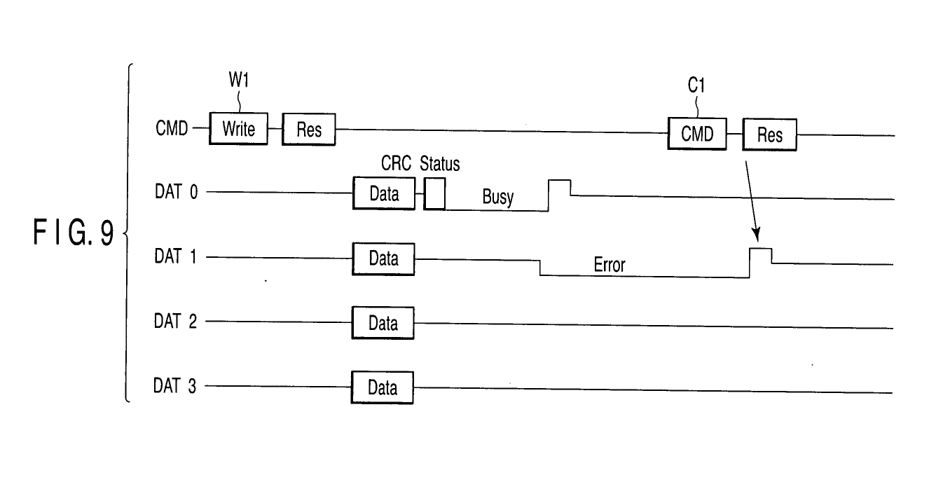

FIG. 9 is a timing chart showing sending and receiving of a signal between the host device 2 and the SD™ memory card 1 when the single write is executed by using 4-bit data lines. The figure specifically illustrates a timing of a signal which passes through the bus interface 3.

When the write command W1 is input from the host device 2 to the host interface unit 13 via a command (CMD) line, a response (Res) signal is sent from the host interface unit 13 to the host device 2. Then, the data blocks are transferred from host device 2 to the host interface unit 13 via the lines of data 0 (DAT0) to data 3 (DAT3). When the host interface unit 13 receives the data blocks, the host interface unit 13 sends the CRC status signal to notify the error occurrence condition as to whether an error occurs during the data transfer, to the host device 2 in the data 0 line. The data 0 line becomes in a Busy state (“L”) indicating that the data blocks are being written, until the data blocks are written in the NAND-type flash memory 11 by the read/write control unit 20.

If an error occurs when the data blocks are written, the data 1 line (DAT1) becomes in an Error state (“L”) indicating the occurrence of the error. When writing the data blocks is ended, the data 0 line is set in a state (“H”) indicating that the writing is ended. When the host device 2 detects rise from the Busy state (“L”) to “H” in the data 0 line, the host device 2 detects whether an error occurs during the writing of the data blocks, by observing the state of the data 1 line.

After that, the command C1 is input from the host device 2 to the host interface unit 13 and the response signal (Res) is sent from the host interface unit 13 to the host device 2. The data 1 line in the Error state is raised from the Error state (“L”) to “H” in response to the command C1 and then to a tristate (high-impedance state). In other words, the Error state indicating that the error occurred is cleared by the input of the command C1 from the host device 2. The command C1 may be a command capable of sending the response signal in response to the input of the command, i.e. a command causing the sending of the response signal in response to the input of the command. For example, the command C1 may be a write command, a read command or the other command. The data 0 line also becomes tristate after it is set in the state (“H”) indicating that the writing is ended.

The data 1 line (DAT1) is defined as an interrupt line under the SDIO standards. FIG. 9 illustrates a state in which since the SD™ memory card 1 detects the occurrence of the error, it operates the data 1 line in “L” (Error state) to notify the host device 2 of the occurrence of the error. The SD™ memory card 1 can notify the host device 2 of the error information at any time when it detects the error. In other words, the data 1 line becomes “L” (Error state) immediately before the data 0 line rises from the Busy state (“L”) to “H”, in FIG. 9. However, the SD™ memory card 1 can operate the data 1 line in “L” (Error state) and notify the host device 2 of the error information at any time immediately after sending the CRC status signal to the host device 2.

Next, “multi-block write” to write the data blocks from the read/write control unit 20 to the NAND-type flash memory 11 at a plurality of times (three times here) in response to the input of a write command, will be explained.

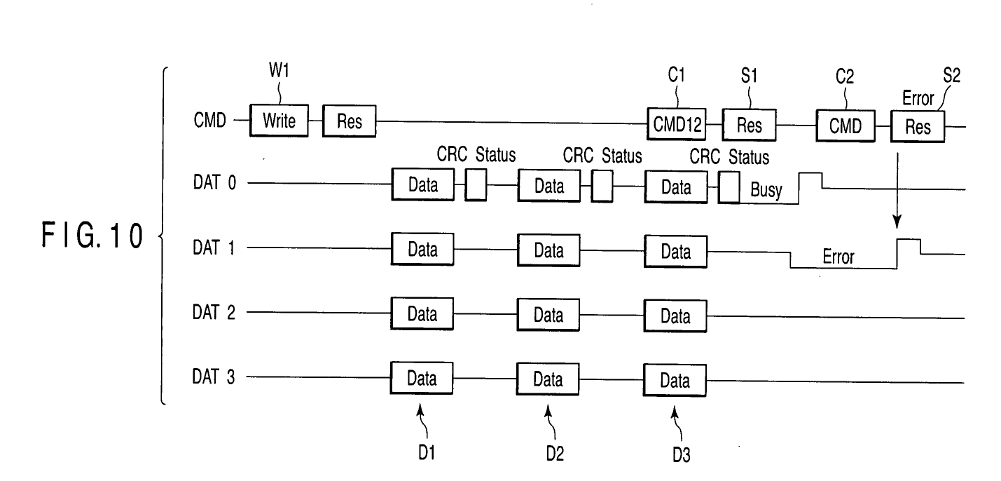

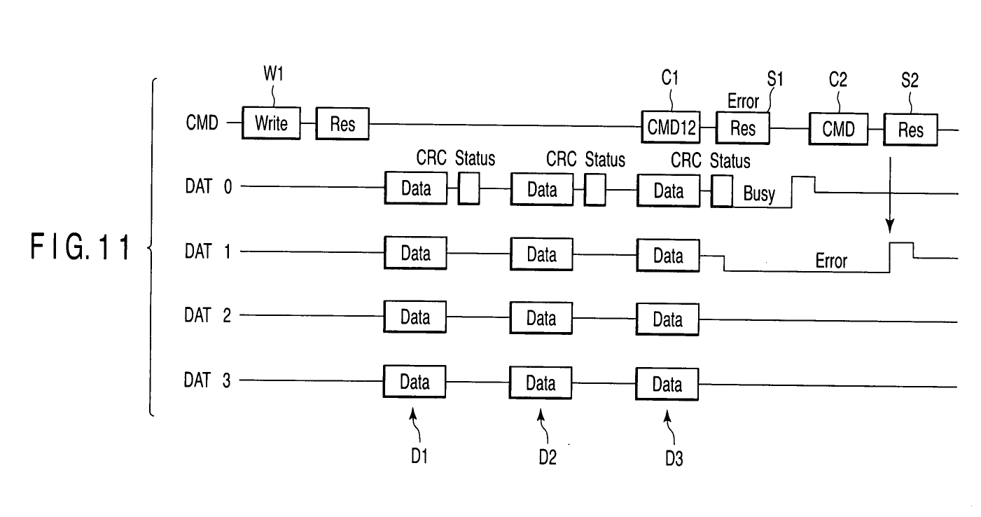

FIG. 10 and FIG. 11 are timing charts showing sending/receiving of a signal between the host device 2 and the SD™ memory card 1 when the multi-block write is executed with the 4-bit data lines. The figures specifically illustrate the timings of the signal which passes through the bus interface 3.

First, an example of the multi-block write will be explained with reference to FIG. 10.

When the write command W1 is input from the host device 2 to the host interface unit 13 via the command (CMD) line, a response signal is sent from the host interface unit 13 to the host device 2. Then, data blocks D1 are transferred from host device 2 to the host interface unit 13 via the lines of data 0 (DAT0) to data 3 (DAT3). When the host interface unit 13 receives the data blocks D1, the host interface unit 13 sends the CRC status signal to notify the error occurrence condition of the data transfer period, to the host device 2 in the data 0 line. Subsequently, data blocks D2 are transferred from the lines of data 0 (DAT0) to data 3 (DAT3). When the host interface unit 13 receives the data blocks D2, the host interface unit 13 sends the CRC status signal to notify the error occurrence condition of the data transfer period, to the host device 2 in the data 0 line.

Furthermore, data blocks D3 are transferred from the lines of data 0 (DAT0) to data 3 (DAT3). When the host interface unit 13 receives the data blocks D3, the host interface unit 13 sends the CRC status signal to notify the error occurrence condition of the data transfer period, to the host device 2 in the data 0 line. The command C1 is input from the host device 2 to the host interface unit 13 via the command (CMD) line, simultaneously with the transfer of the data blocks D3. The command C1 indicates the last transfer of the data blocks from the host device 2 to the host interface unit 13. In other words, the transfer of the write data from the host device 2 to the host interface unit 13 is ended by the input of the command C1. After the last CRC status signal is sent, the data 0 line becomes in a Busy state (“L”) indicating that the data is being written, until the data blocks D1 to D3 are written in the NAND-type flash memory 11 by the read/write control unit 20.

When the command C1 is input, response signal S1 is sent from the host interface unit 13. Since no error occurs before the response signal S1 is sent, an error is not displayed on the response signal S1 responding to the command C1.

After that, when an error occurs during the writing of the data blocks D1 to D3 in the NAND-type flash memory 11, i.e. when an error occurs in the Busy state, the data 1 line (DAT1) becomes in the Error state (“L”) indicating the occurrence of the error, and error interrupt occurs in the data 1 line. When writing the data blocks is ended, the data 0 line is set in a state (“H”) indicating that the writing is ended. When the host device 2 detects the rise from the Busy state (“L”) to “H” in the data 0 line, the host device 2 detects whether an error occurs during the writing of the data blocks D1 to D3, by observing the state of the data 1 line.

After that, command C2 is input from the host device 2 to the host interface unit 13 and response signal (Res) S2 is sent from the host interface unit 13 to the host device 2. At this time, since the error occurs after sending the response signal S1 responding to the command C1, the error is displayed on the response signal S2 responding to the command C2. In other words, in response to the command C2, the host device 2 reads the error information retained by the card status register arranged inside the register unit 19 and receives the error information by the response signal S2. The data 1 line indicating the Error state is raised from the Error state (“L”) to “H” in response to the response signal S2 responding to the command C2 and then to a tristate (high-impedance state). In other words, the Error state indicating that the error occurred is cleared by the input of the command C2 from the host device 2. The data 0 line also becomes tristate after it is set in the state (“H”) indicating that the writing is ended.

Next, another example of the multi-block write will be explained with reference to the timing chart of FIG. 11.

The error information is displayed on the response signal S1 responding to the command C1 in FIG. 11 while the error information is displayed on the response signal S2 responding to the command C2 in FIG. 10.

The data blocks D1 to D3 are transferred to the host interface unit 13, similarly to the example of FIG. 10. When the command C1 is input simultaneously with the transfer of the data block D3, the response signal S1 is sent from the host interface unit 13. Since an error has occurred before sending the response signal S, the error is displayed on the response signal S responding to the command C1. In other words, the host device 2 reads the error information retained by the card status register arranged inside the register unit 19 and receives the error information by the response signal S1, in response to the command C1.

Synchronously with the error display, the data 1 line (DAT1) becomes in an Error state (“L”) indicating the occurrence of the error and the error interrupt occurs in the data 1 line. When writing the data blocks is ended, the data 0 line is set in a state (“H”) indicating that the writing is ended. When the host device 2 detects the rise from the Busy state (“L”) to “H” in the data 0 line, the host device 2 detects whether an error occurs during the writing of the data blocks D1 to D3, by observing the state of the data 1 line.

After that, the command C2 is input from the host device 2 to the host interface unit 13 and the response signal (Res) S2 is sent from the host interface unit 13 to the host device 2. At this time, the error information is displayed on the response signal S1 responding to the command C1 while it is not displayed on the response signal S2 responding to the command C2. The data 1 line in the Error state is raised from the Error state (“L”) to “H” in response to the response signal S2 responding to the command C2 and then to a tristate (high-impedance state). In other words, the Error state indicating that the error occurred is cleared by the input of the command C2 from the host device 2. According to the multi-block write, when the error is detected during the data transfer, the error information is notified by the CRC status signal sent from the data 0 line after receiving the data blocks. The CRC status signal is the information which indicates whether the data from the bus interface 3 is normally received by the host interface unit 13. The CRC status signal has a function of notifying the occurrence of the error by not sending the CRC status signal, other than displaying the error information.

In the operations shown in FIG. 9, FIG. 10 and FIG. 11, if an error occurs during the writing time, the error information is stored in the card status register arranged inside the register unit 19. In the interrupt cycle, the error signal is output from the data 1 line to the host device 2 and the error information is displayed on the response signal responding to the command. If an error occurs during the data transfer from the host device 2 to the host interface unit 13, the error information is stored in the card status register arranged in the register unit 19, and the error information is displayed on the CRC status signal set after receiving the data and is notified to the host device 2. The host device 2 can thereby detect the occurrence of the error without sending to the SD™ memory card 1 the command for confirming whether the error occurred. Since the host device 2 does not need to issue the command for confirming whether the error occurred, a method of controlling the SD™ memory card in the general operation which does not include the occurrence of the error can be simplified. Since the number of issuing the commands can be thereby reduced, the control efficiency can be enhanced. In addition, since the error signal which is output from the data 1 line due to the occurrence of the error can be cleared by the command sent from the host device 2, the operation can be quickly shifted to the following step.

In the first embodiment, the occurrence of the error is notified to the host device by the interrupt defined as the SDIO. The host device can monitor the occurrence of the error by detecting the interrupt alone. Therefore, controlling the SD™ memory card by the host device can be simplified and the efficiency of the general access operation can be improved.

### Second Embodiment

Next, an SD™ memory card according to a second embodiment of the present invention will be described. Elements like or similar to those disclosed in the first embodiment are denoted by similar reference numbers and are not explained in detail while the different elements alone are explained below.

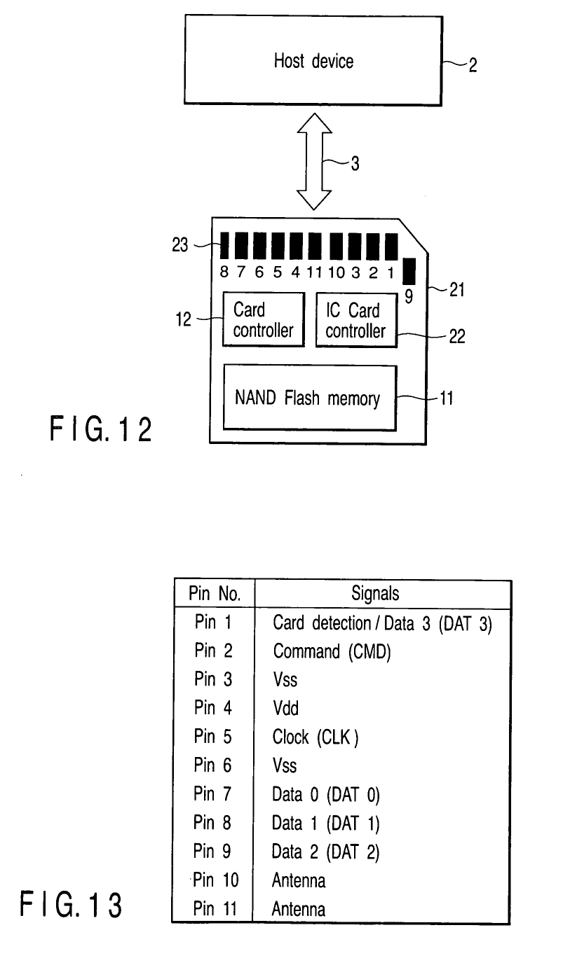

FIG. 12 schematically shows a structure of an SD™ memory card according to the second embodiment. An SD™ memory card 21 sends information to the host device 2 or receives information therefrom via the bus interface 3. The SD™ memory card 21 comprises a pin 10 and a pin 11 connected to an antenna for non-contact communications.

The pin 10 and the pin 11 are electrically connected to an IC card controller 22. Signals are assigned to the pins 1 to 11, of a plurality of pins 23, for example, as shown in FIG. 13.

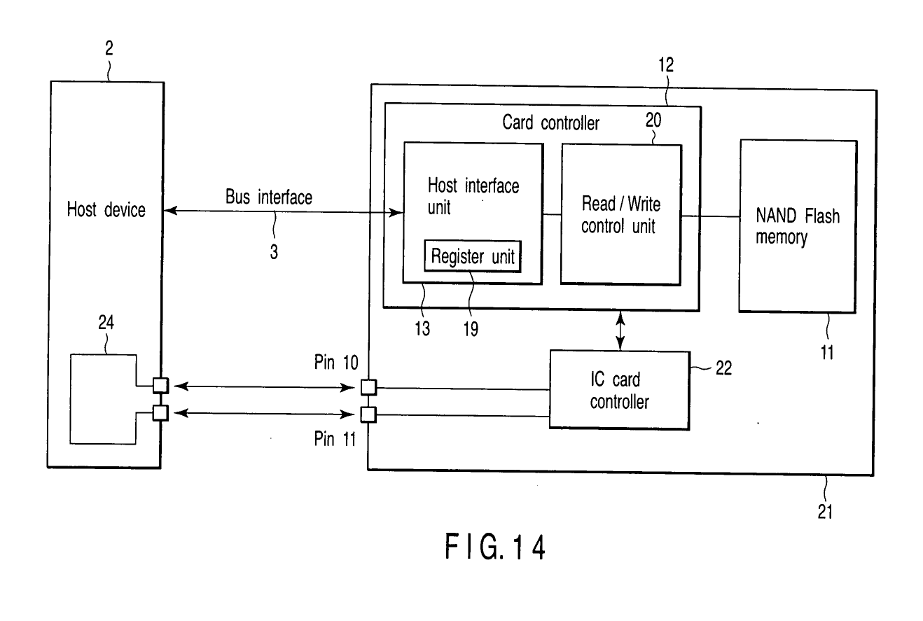

FIG. 14 is a functional block diagram showing a structure of the SD™ memory card according to the second embodiment.

The SD™ memory card 21 is accessed by the host device 2 via the bus interface 3 to send the information to the host device 2 or receive the information therefrom. The SD™ memory card 21 includes the NAND-type flash memory 11, the card controller 12 and the IC card controller 22. The host device 2 comprises an antenna (wireless communications unit) 24 for non-contact communications. The pin 10 and the pin 11 are connected to the antenna 24 by loading the SD™ memory card 21 in the card slot of the host device 2. The antenna 24 receives information such as various kinds of signals and data without making a contact with an information sending medium and transfers the information to the IC card controller 22. The IC card controller 22 outputs the information sent by the wireless communications using the antenna 24 (i.e. the information which is received or is being received by the antenna 24, for example, the information indicating the start and end of the communications), to the host device 2 via the bus interface 3 by the host interface unit 13, during the interrupt cycle period. The host interface unit 13 has mode changing means, similarly to the first embodiment. The mode changing means changes the mode of outputting the above-explained information and the mode of not outputting the information. For example, when the SD™ memory card 21 is initialized, the mode changing means changes the mode to the mode of outputting the information if a predetermined command is input, and to the mode of not outputting the information if a predetermined command is not input. Similarly to the first embodiment, the host interface unit 13 also has a function of stopping the output of the information when the predetermined command is input.

In the SD™ memory card 21 having the wireless communication function, interfaces other than the bus interface 3 may make an access to the NAND-type flash memory 11. Conditions of the conventional SD™ memory card cannot be detected if the host device 2 does not execute polling by issuing the command. In the second embodiment, however, the information can be acquired from the SD™ memory card without polling executed by the host device 2, by notifying the host device 2 of the conditions of the SD™ memory card in the wireless communications or the information acquired by the wireless communications by means of the interrupt.

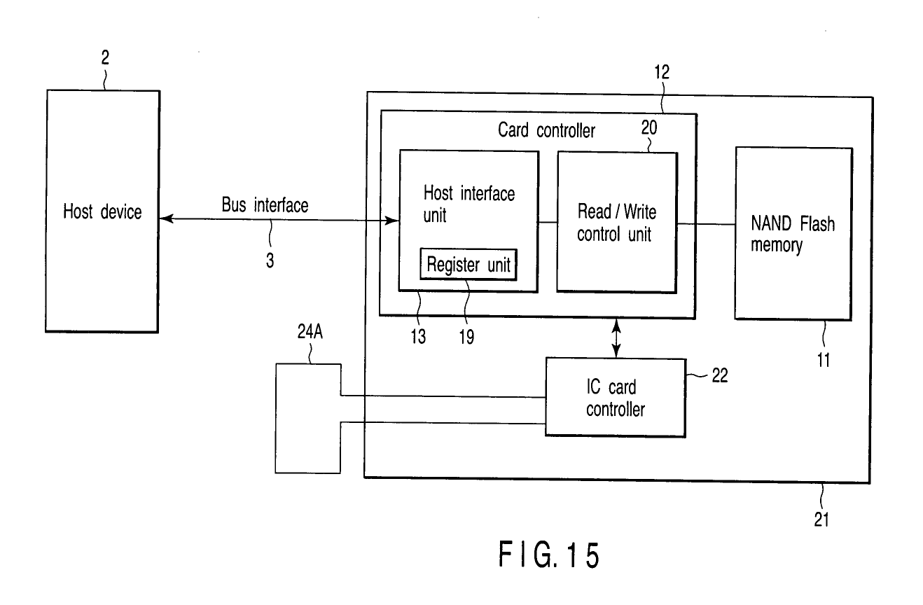

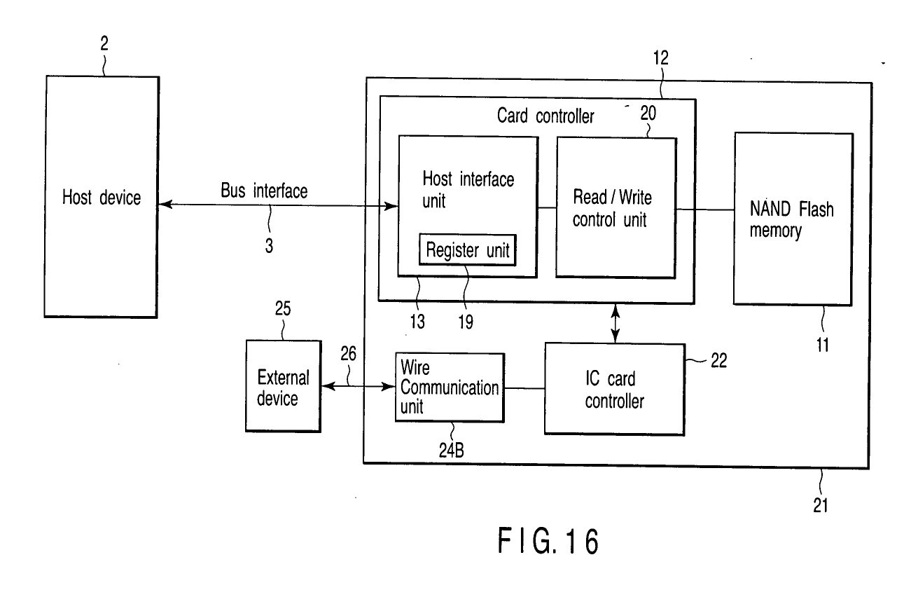

FIG. 15 shows a structure of a first modified example of the second embodiment. FIG. 16 shows a structure of a second modified example of the second embodiment. In FIG. 15, an antenna (wireless communications unit) 24A for non-contact communications is provided in the memory card 21. In FIG. 16, a wire communications unit 24B is provided in the memory card 21. The wire communications unit 24B of FIG. 16 carries out communications with an external device 25 via a bus interface 26. The other main constituent elements and operations are the same as those of the memory card of the second embodiment.

In each of the above-described embodiments, the memory card is the SD™ memory card, but is not limited thereto. In addition, the interrupt is an interrupt defined by the SDIO, but is not limited thereto.

According to the embodiments, the present invention can provide a memory card and a card controller thereof, capable of notifying the host device of an error occurring in the memory card without issuing a command for confirming whether an error occurred, and of simplifying a method of controlling the memory card and enhancing the efficiency of the control. In addition, the present invention can provide a memory card and a card controller thereof, comprising means for notifying the host device that an event occurred, by the wireless communications or wire communications.

The above-described embodiments cannot only be accomplished separately, but can be combined in appropriate manners. Furthermore, the embodiments contain various aspects of the invention. Thus, various aspects of the invention can also be extracted from any appropriate combination of a plurality of constituent elements disclosed in the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A card controller built in a memory card capable of being loaded in a host device which can detect interrupt, the card controller comprising:
an interface unit which receives and decodes a command from the host device, sends a response to the host device, and sends data to the host device and receives data therefrom;
a read/write control unit which executes at least one of writing and reading of the data in accordance with a result of decoding the command;
an error detecting unit which detects whether an error occurred in the sending and receiving of the data executed by the interface unit, and in at least one of the writing and reading of the data executed by the read/write control unit; and
a signal processing unit which outputs an interrupt signal to the host device via the interface unit during a period in which the interface unit does not execute sending or receiving the data, when the error detecting unit detects the occurrence of the error.

2. The card controller according to claim 1, wherein when the predetermined command is input from the host device to the interface unit, the interface unit stops the output of the interrupt signal and ends an interrupt cycle.

3. The card controller according to claim 1, wherein in accordance with the predetermined command input from the host device, the interface unit changes a mode of outputting the interrupt signal and a mode of not outputting the interrupt signal.

4. The card controller according to claim 1, further comprising a register which retains error information indicating the occurrence of the error when the error detecting unit detects the occurrence of the error, wherein when the host device receives the interrupt signal, the host device confirms the occurrence of the error by reading the error information retained by the register.

5. A card controller built in a memory card capable of being loaded in a host device which can detect interrupt, the card controller comprising:
a communications unit which sends information to an external device and receives information therefrom;
an interface unit which receives and decodes a command from the host device, sends a response to the host device, and sends data to the host device and receives data therefrom;
a read/write control unit which executes at least one of writing and reading of the data in accordance with a result of decoding the command; and
a signal processing unit which outputs predetermined information sent from the communications unit to the host device via the interface unit, as an interrupt signal, during a period in which the interface unit does not execute sending and receiving of the data.

6. The card controller according to claim 5, wherein when the predetermined command is input from the host device to the interface unit, the interface unit stops the output of the interrupt signal and ends an interrupt cycle.

7. The card controller according to claim 5, wherein in accordance with the predetermined command input from the host device, the interface unit changes a mode of outputting the interrupt signal and a mode of not outputting the interrupt signal.

8. The card controller according to claim 5, wherein the predetermined information is information which indicates that the communications unit starts or ends communications.

9. The card controller according to claim 5, wherein the predetermined information is received from the external device by the communication unit.

10. A memory card capable of being loaded in a host device which can detect interrupt and being accessed by the host device, the memory card comprising:
an interface unit which receives and decodes a command from the host device, sends a response to the host device, and sends data to the host device and receives data therefrom;
a memory which stores the data;
a read/write control unit which executes at least one of writing of the data to the memory and reading of the data therefrom in accordance with a result of decoding the command;
an error detecting unit which detects whether an error occurred in the sending and receiving of the data executed by the interface unit, and in at least one of the writing and reading of the data executed by the read/write control unit; and
a signal processing unit which outputs an interrupt signal to the host device via the interface unit during a period in which the interface unit does not execute sending or receiving the data, when the error detecting unit detects the occurrence of the error.

11. The memory card according to claim 10, wherein when the predetermined command is input from the host device to the interface unit, the interface unit stops the output of the interrupt signal and ends an interrupt cycle.

12. The memory card according to claim 10, wherein in accordance with the predetermined command input from the host device, the interface unit changes a mode of outputting the interrupt signal and a mode of not outputting the interrupt signal.

13. The memory card according to claim 10, further comprising a register which retains error information indicating the occurrence of the error when the error detecting unit detects the occurrence of the error,
wherein when the host device receives the interrupt signal, the host device confirms the occurrence of the error by reading the error information retained by the register.

14. A memory card capable of being loaded in a host device which can detect interrupt and being accessed by the host device, the memory card comprising:
a communications unit which sends information to an external device and receives information therefrom;
an interface unit which receives and decodes a command from the host device, sends a response to the host device, and sends data to the host device and receives data therefrom;
a memory which stores the data;
a read/write control unit which executes at least one of writing of the data to the memory and reading of the data therefrom in accordance with a result of decoding the command; and
a signal processing unit which outputs predetermined information sent from the communications unit to the host device via the interface unit, as an interrupt signal, during a period in which the interface unit does not execute sending and receiving of the data.

15. The memory card according to claim 14, wherein when the predetermined command is input from the host device to the interface unit, the interface unit stops the output of the interrupt signal and ends an interrupt cycle.

16. The memory card according to claim 14, wherein in accordance with the predetermined command input from the host device, the interface unit changes a mode of outputting the interrupt signal and a mode of not outputting the interrupt signal.

17. The memory card according to claim 14, wherein the predetermined information is information which indicates that the communications unit starts or ends communications.

18. The memory card according to claim 14, wherein the predetermined information is received from the external device by the communication unit.
